(19) United States
(12) Patent Application Publication
(10) Pub. No.: US 2017/0110039 A1
(43) Pub. Date: Apr. 20, 2017

(54) NO FLIP FLAG CLIP

(71) Applicants: Jay Jenkins, Folsom, PA (US); Howard L Kelly, Centreville, VA (US)

(72) Inventors: Jay Jenkins, Folsom, PA (US); Howard L Kelly, Centreville, VA (US)

(21) Appl. No.: 14/886,027

(22) Filed: Oct. 17, 2015

(51) Int. Cl. G09F 17/00; F16B 2/22; E04H 12/32

(52) U.S. Cl. CPC G09F 17/00; E04H 12/32; F16B 2/22; G09F 2017/0008

(57) ABSTRACT

The No Flip Flag Clip is a clip that prevents flags from wrapping around, or becoming entangled with, a flag pole. The No Flip Flag Clip slides over the flag pole and on both sides of a flag to stabilize the flag relative to the flag and prevents the flag from wrapping around the flag pole, or from becoming entangled with the flag pole. The No Flip Flag Clip is made of a transparent plastic material that does not affect the appearance of the flag.

### BACKGROUND OF THE INVENTION

This invention relates, in general, to a clip that prevents flags and banners from wrapping around, or becoming entangled with, a flag pole, or other support. The No Flip Flag Clip slides over the flag pole and on both sides of a flag to stabilize the flag relative to the flag and prevents the flag from wrapping around the flag pole, or from becoming entangled with the flag pole. The No Flip Flag Clip is made of a transparent plastic material that does not affect the appearance of the flag.

Flags and banners are displayed on poles by a variety of means. A common method is the use of eyelets on the flag or banner, and a rope with clips mounted on a pole by one or more pulleys. The clips connect to the eyelets and the rope is pulled to hoist the flag or banner. Another method is the use of a long pocket on the side of the flag or banner. The pole is inserted into the pocket then placed in a flag holder bracket. The prior art discussed below is concerned with flags mounted using eyelets and clips, and would not work with a pocket type mounting. The No Flip Flag Clip will work with all types of flag mountings.

### DESCRIPTION OF THE PRIOR ART

In the prior art various types of devices have been proposed. A few examples are cited below.

U.S. Pat. No. 1,277,347 was issued on Sep. 3, 1918, to Allen for a Non-Tangling Device For Flags. This reference shows an anti-tangling device made of wire with spring clips at the ends for attaching to the side of a flag. The rigidity of the wire prevents the flag from wrapping around the pole. This invention is very different from the No Flip Flag Clip and is representative of several patents of similar design.

U.S. Pat. No. 1,283,136 was issued on Oct. 29, 1918, to Foulkes for a Non-Tangling Device For Flags. This reference shows U-shaped rod loosely mounted on a flag pole with the arms extending on either side of the flag, but not clamping the flag. The rod is held in place at the middle of a flag by a clip connecting the rod to the flag. This invention is very similar in shape to the No Flip Flag Clip. The differences are in the material used and the type of contact with the flag.

U.S. Pat. No. 2,527,357 was issued on Oct. 24, 1950, to Donahey for a Flag And Flagstaff Assembly With Air Deflector. This reference shows an V-shaped air deflector made of a transparent material that snaps around the flag pole and diverts the air stream away from the flag. This invention is similar in construction to the No Flip Flag Clip, but does not touch the flag, and extends for the width of the flag.

U.S. Pat. No. 3,820,500 was issued on Jun. 28, 1974, to Merryweather for a Flag Pole Combination. This reference shows a U-shaped rod which extends on each side, and away from, a flag. The rod is attached to the flag pole in a way which allows the flag to blown side to side by the wind, but not become tangled around the pole. This is also very similar in shape to the No Flip Flag Clip. The differences are in the material, construction and mounting of the device.

U.S. Patent Application Publication 2005/0199176 was published on Sep. 15, 2005, filed by Orton et al. for a Anti-Wrap System And Device. This reference shows a U-shaped transparent bar extending on either side of a flag, and clamping the flag. The U-shaped bar is mounted in a clamp which is fastened to the flag pole and also provides a clamping force to the U-shaped bar. This invention is the closest to the No Flip Flag Clip. The differences are the complex clamp used to connect it to the flag pole and the shape of the bar.

### SUMMARY OF THE INVENTION

The present invention is directed to a clip that prevents flags from wrapping around, or becoming entangled with, a flag pole.

It is an object of the present invention to provide a new and improved flag clip that is easy to install and remove.

It is an object of the present invention to provide a new and improved flag clip which is transparent and does not affect the appearance of the flag.

It is an object of the present invention to provide a new and improved flag clip that will prevent the flag from wrapping around the flag pole.

It is an object of the present invention to provide a new and improved flag clip that will prevent the flag from becoming entangled with the flag pole.

It is an object of the present invention to provide a new and improved flag clip that will not require any modifications to the flag.

It is an object of the present invention to provide a new and improved flag clip that will work on banners which have a pocket sleeve mounting design, with no open space between their main flag portion and their mounting pole.

These and other objects and advantages of the present invention will be fully apparent from the following description, when taken in connection with the annexed drawings.

### BRIEF DESCRIPTION OF THE DRAWINGS

FIG. 1 is a side view of the present invention.

FIG. 2 is a view of the present invention in use with a flag.

FIG. 3 is a second embodiment of the present invention.

FIG. 4 is a third embodiment of the present invention.

### DESCRIPTION OF THE PREFERRED EMBODIMENT

The preferred embodiment herein described is not intended to be exhaustive or to limit the invention to the precise form disclosed. It is chosen and described to best explain the invention so that others, skilled in the art to which the invention pertains, might utilize its teachings.

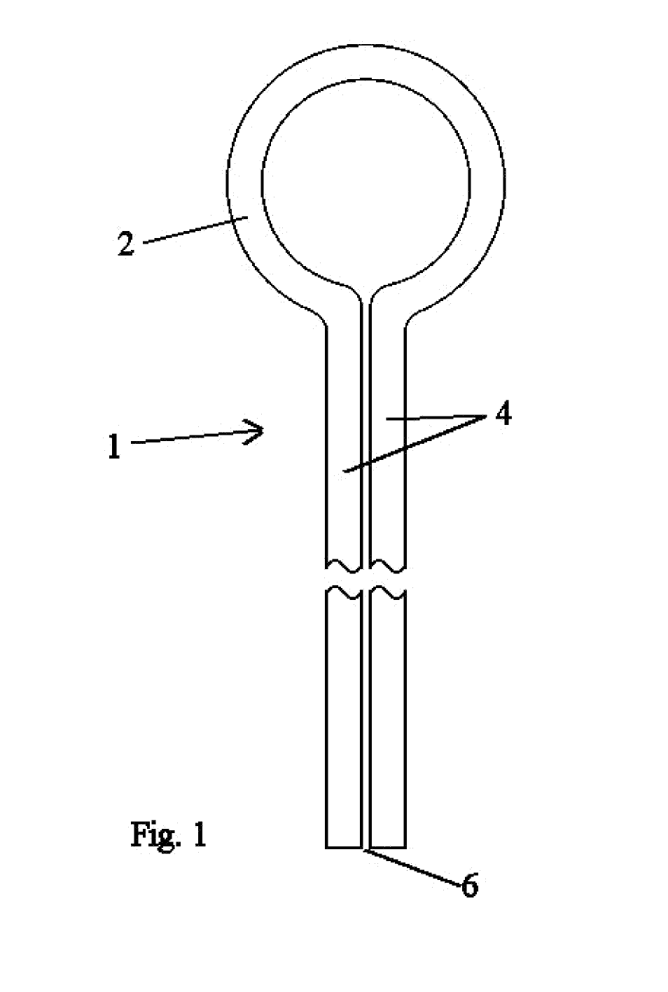

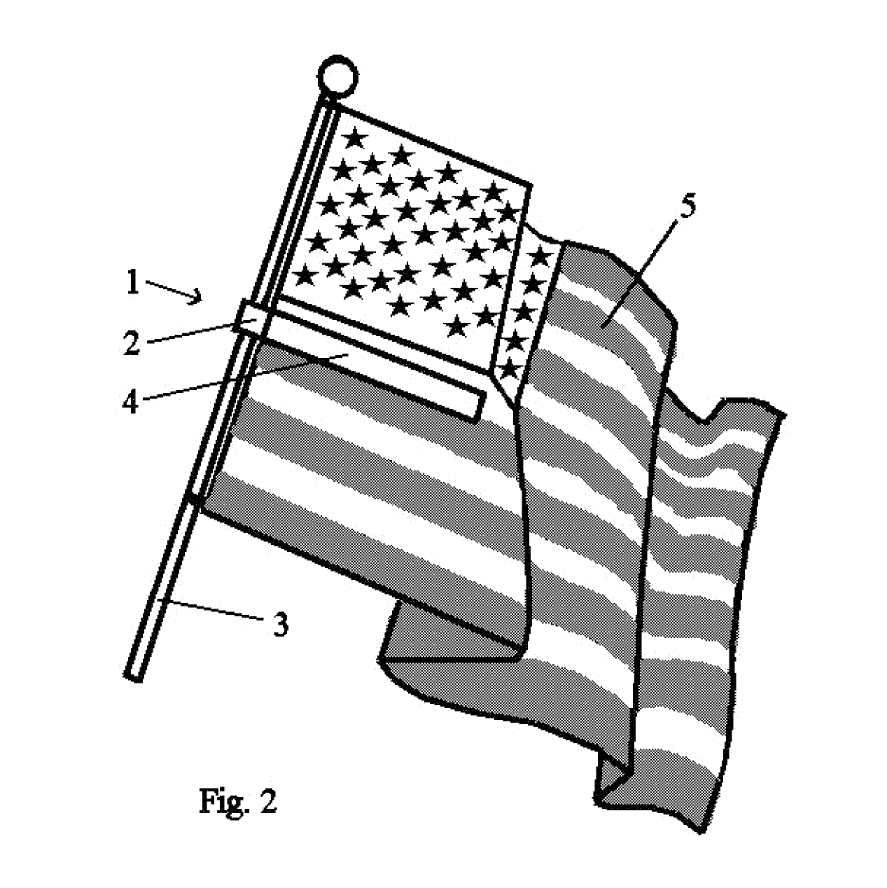

Referring now to the drawings in greater detail, FIG. 1 shows a side view of the flag clip 1. The flag clip 1 is a made from a single piece of transparent plastic, such as Plexiglas®. The transparent plastic has a width of about one inch, and a thickness of about 3/16th inch. The flag clip has a round section 2 which fits around a flag pole 3 (seen in FIG. 2). The round section 2 is connected to two arms 4 which extend on both sides of a flag 5 (seen in FIG. 2). The arms are about 12 inches long. There is a small gap 6 between the two arms 4 to accommodate the thickness of the flag material. The gap 6 may be reduced to zero if desired. The thickness, width and length of the transparent plastic material may be larger or smaller as desired for the size of the flag 5.

FIG. 2 shows the flag clip 1 in use on a flag 5. The flag 5 is attached to a flag pole 3 by conventional methods. The most common conventional methods include the use of grommets (not shown) on the flag or banner, and a rope (not shown) with clips (not shown) mounted on a pole by one or more pulleys. The clips connect to the grommets and the rope is pulled to hoist the flag or banner. Another popular method, especially with banners, is the use of a long pocket or sleeve (not shown) on the side of the flag or banner. The pole is inserted into the pocket or sleeve then placed in a flag holder bracket. The flag clip is passed over and around the flag pole 3 with the round section 2 surrounding the flag pole 3 and the two arms 4 extending on both sides of the flag 5. The arms 4 prevent the distal end of the flag from wrapping around the flag pole 3, and from gaining a purchase by which the flag 5 would become entangled on the flag pole 3.

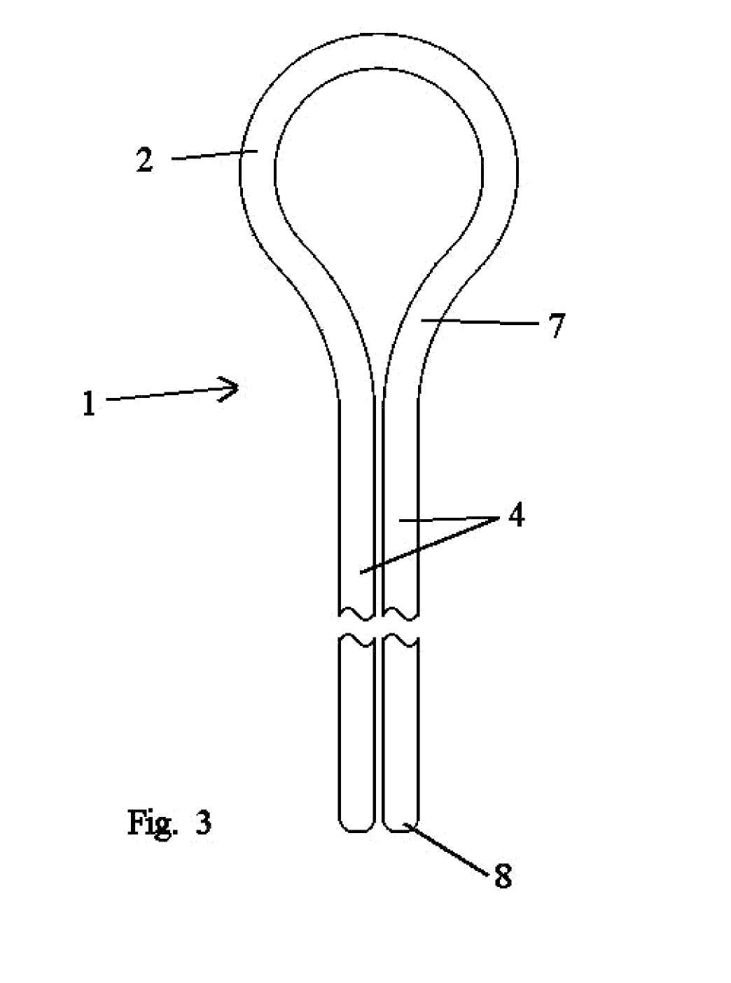

FIG. 3 shows a second embodiment of the flag clip 1 for use with a larger diameter flag pole 3. When the flag clip 1 is installed on a larger diameter flag pole 3 the additional stress on the round section 2 caused by the arms 4 spreading apart to fit around the pole may cause the flag clip 1 to break. To prevent this from happening, the round section 2 and the arms 3 are connected by a curved transition section 7. The curved transition section 7 will allow the flag clip 1 to be installed on a flag pole 3 with less stress on the round section 2. The ends 8 of the arms 4 are rounded to prevent the shape edges of the flag clip 1 from damaging the flag 5. The body of the flag clip 1 may also be rounded to prevent wear damage to the flag 5.

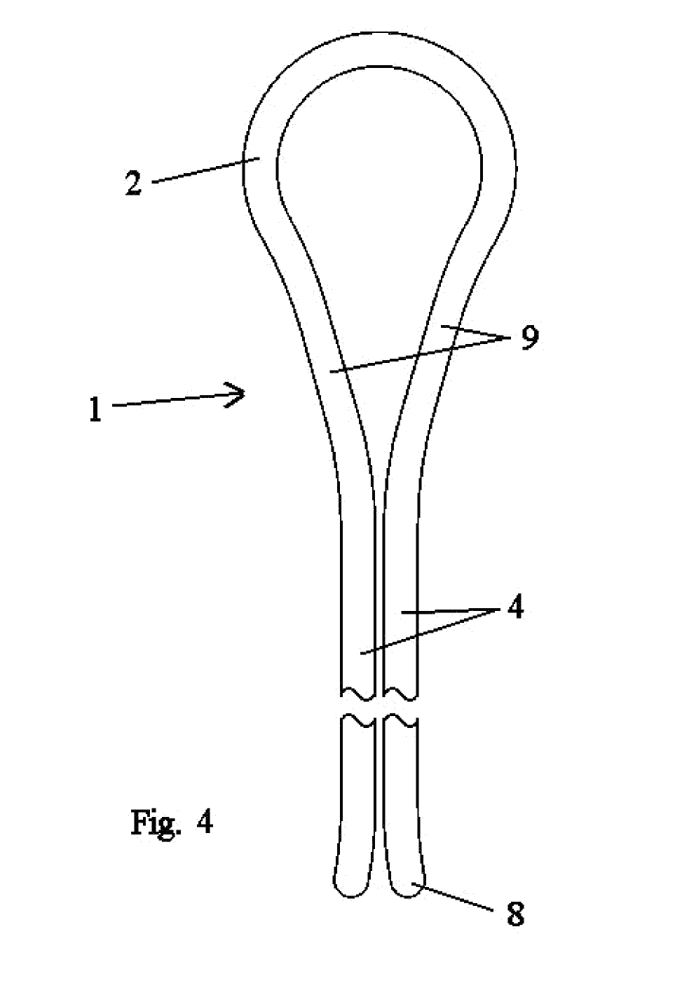

FIG. 4 shows a third embodiment of the flag clip 1 also for use with a larger diameter flag pole 3. To alleviate the stress on the round section 2, the round section 2 and the arms 3 are connected by a angled straight transition section 9. The angled straight transition section 9 further reduces the stress on the round section 2 when the flag clip 1 is installed on a larger flag pole 3. In this embodiment, in addition to being rounded the ends 8 of the arms 4 are bend outward slightly to make it easier to slip the flag clip 1 over the flag 5.

The thickness and width of the material used to construct the flag clip 1 may be larger or smaller as desired for the size of the flag 5.

Although the No Flip Flag Clip and the method of using the same according to the present invention has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

1-8. (canceled)

9. A flag mounted on a flag pole and a flag clip to prevent said flag from wrapping around said flag pole;
said flag having opposite sides
said flag clip comprising: an elongated material;
said elongated material having a width and a length, said width being less than said length.
said elongated material having a center section, two outer sections and edges;
said two outer sections being located on either side of said center section along said length of said elongated material.
said center section of said elongated material being shaped to fit around said flag pole;
said outer sections of said elongated material extending away from said center section;
said outer sections being parallel to each other;
said outer sections spaced apart so as to press against said opposite sides of said flag.

10. A flag clip as claimed in claim 9, wherein said elongated material is a contiguous length of transparent plastic.

11. A flag clip as claimed in claim 9 wherein said edges of said elongated material being rounded.

12. A flag clip as claimed in claim 9 wherein outer sections of said elongated material have distal ends, said distal ends being bent away from each other.

13. A flag clip as claimed in claim 9 wherein said center section and said outer sections are connected by a curved transition section.

14. A flag clip as claimed in claim 9 wherein said center section and said outer sections are connected by an angled straight transition section.

15. A flag mounted on a flag pole and a flag clip to prevent said flag from wrapping around said flag pole;
said flag having opposite sides
said flag clip comprising: an elongated material;
said elongated material being a contiguous length of transparent plastic;
said elongated material having a width and a length, said width being less than said length.
said elongated material having a center section, two outer sections and edges;
said two outer sections being located on either side of said center section along said length of said elongated material.
said edges of said elongated material being rounded;
said outer sections having distal ends;
said center section of said elongated material being shaped to fit around said flag pole;
said outer sections of said elongated material extending away from said center section;
said outer sections being parallel to each other;
said outer sections spaced apart so as to press against said opposite sides of said flag
said distal ends being bent away from each other;
said center section and said outer sections being connected by a curved transition section.

16. A flag mounted on a flag pole and a flag clip to prevent said flag from wrapping around said flag pole;
said flag having opposite sides
said flag clip comprising: an elongated material;
said elongated material being a contiguous length of transparent plastic;
said elongated material having a width and a length, said width being less than said length.
said elongated material having a center section, two outer sections and edges;
said two outer sections being located on either side of said center section along said length of said elongated material.
said edges of said elongated material being rounded;
said outer sections having distal ends;
said center section of said elongated material being shaped to fit around said flag pole;
said outer sections of said elongated material extending away from said center section;
said outer sections being parallel to each other;
said outer sections spaced apart so as to press against said opposite sides of said flag
said distal ends being bent away from each other;
said center section and said outer sections being connected by a straight transition section.
